(19) United States
(12) Patent Application Publication
(10) Pub. No.: US 2011/0242142 A1
(43) Pub. Date: Oct. 6, 2011

(54) MULTIPLE DISPLAY CHROMINANCE AND LUMINANCE METHOD AND APPARATUS

(75) Inventors: Syed Athar Hussain, Scarborough (CA); Jeffrey G. Cheng, Toronto (CA)

(73) Assignee: ATI TECHNOLOGIES ULC, Markham (CA)

(21) Appl. No.: 13/052,761

(22) Filed: Mar. 21, 2011

Related U.S. Application Data
(60) Provisional application No. 61/319,115, filed on Mar. 30, 2010.

(51) Int. Cl. G09G 5/10

(52) U.S. Cl. 345/690

(57) ABSTRACT

An apparatus includes a chrominance and luminance module. The chrominance and luminance module obtains display characteristics of each of a plurality of displays. The chrominance and luminance module selectively adjusts, on a per display basis, chrominance and luminance for each of the displays based on the display characteristics. In one example, the displays collectively display a single large surface.

### CROSS-REFERENCE TO RELATED APPLICATION

This application claims priority to the provisional patent application having Application No. 61/319,115, filed Mar. 30, 2010, having inventors Syed Athar Hussain and Jeffrey Cheng, and owned by instant assignee, for “MULTIPLE DISPLAY CHROMINANCE AND LUMINANCE METHOD AND APPARATUS” and is hereby incorporated by reference in its entirety.

### FIELD OF THE DISCLOSURE

The present disclosure generally relates to chrominance and luminance methods and apparatus, and more particularly, to methods and apparatus for providing chrominance and luminance for multiple displays.

### BACKGROUND OF THE DISCLOSURE

Some modern computer systems are known to drive multiple displays in a manner to collectively present a single large surface amongst the displays, which can be a cost effective solution to display a single large surface having a high resolution. However, one or more of the displays may have different display characteristics than other displays. For example, one or more displays may be made by different manufacturers and/or one or more displays may be different model types. As such, when presenting a processed image for display as a single large surface or for other purposes, one or more displays may have varying chrominance and/or luminance characteristics making the presented single large surface appear inconsistent across the multiple displays, which is undesirable.

Accordingly, a need exists for a method and apparatus that can overcome one or more of the aforementioned disadvantages.

### BRIEF DESCRIPTION OF THE DRAWINGS

The invention will be more readily understood in view of the following description when accompanied by the below figures, wherein like reference numerals represent like elements:

FIG. 1 is an exemplary depiction of a device including a chrominance and luminance module according to the present disclosure;

FIG. 2 is an exemplary functional block diagram of the chrominance and luminance module;

FIG. 3 is a flowchart depicting exemplary operations that can be performed by the chrominance and luminance module;

FIG. 4 is a flowchart depicting exemplary operations that can be performed by the chrominance and luminance module; and

FIG. 5 is a flowchart depicting exemplary operations that can be performed by the chrominance and luminance module.

### DETAILED DESCRIPTION OF THE PREFERRED EMBODIMENTS

In one example, an apparatus includes a chrominance and luminance module. The chrominance and luminance module obtains display characteristics of each of a plurality of displays. The chrominance and luminance module selectively adjusts, on a per display basis, chrominance and luminance for each of the displays based on the display characteristics. In one example, the displays collectively display a single large surface. A related method is also disclosed.

The method and apparatus provide, among other advantages, a substantially equivalent chrominance and luminance across the displays, for example, when displaying the single large surface. As such, different makes and/or models of displays can be used in conjunction to display the single large surface without having differing chrominance and luminance characteristic for the various displays. Other advantages will be recognized by those of ordinary skill in the art.

In one example, the chrominance and luminance module selectively adjusts the chrominance and luminance for each of the plurality of displays based on display characteristics of each of the plurality of displays. In one example, the chrominance and luminance module adjusts the chrominance based on a common chrominance range that each of the displays are capable of presenting. The common chrominance range is based on the display characteristics of the plurality of displays. In one example, the chrominance and luminance module selectively adjusts the luminance based on a common luminance range that each of the displays are capable of presenting. The common luminance range is based on the display characteristics of the plurality of displays.

In one example, the display characteristics comprise information in accordance with extended display identification data and/or display identification data. In another example, the display characteristics are based on a visual perception of the plurality of displays collectively displaying the single large surface.

In one example, the chrominance and luminance of each of the plurality of displays are individually adjusted to provide a substantially equivalent chrominance and luminance across all of the plurality of displays when displaying the single large surface.

In one example, an apparatus includes a chrominance module, a luminance module, and a control module. The chrominance module selectively provides, on a per display basis, adjusted chrominance display information for each of a plurality of displays in response to image information. The luminance module selectively provides, on a per display basis, adjusted luminance image information for each of the plurality of displays in response to the adjusted chrominance image information. The control module, which is operatively coupled to the chrominance module and the luminance module, controls the chrominance module to provide the provide the adjusted chrominance image information and the luminance module to provide the adjusted luminance information based on display characteristics of each of the plurality of displays, wherein the plurality of displays are operative to collectively display a single large surface.

In one example, the chrominance module provides the adjusted chrominance image information based on the common chrominance range that each of the displays are capable of presenting, wherein the common chrominance range is based on the display characteristics of the plurality of displays.

The following description of the embodiments is merely exemplary in nature and is in no way intended to limit the invention, its application, or uses. For purposes of clarity, the same reference numbers will be used in the drawings to identify similar elements.

As used herein, the term “module” can include an electronic circuit, one or more processors (e.g., shared, dedicated, or group of processors such as but not limited to microprocessors, DSPs, or central processing units) and memory that execute one or more software or firmware programs, combinational logic circuits, an ASIC, and/or other suitable components that provide the described functionality. Additionally, the term “signal” may refer to one or more currents, one or more voltages, or a data signal. Furthermore, as will be appreciated by those of ordinary skill in the art, the layout of a “module” can be described and laid out in a hardware description language such as Verilog™, VHDL, and/or other suitable hardware description languages.

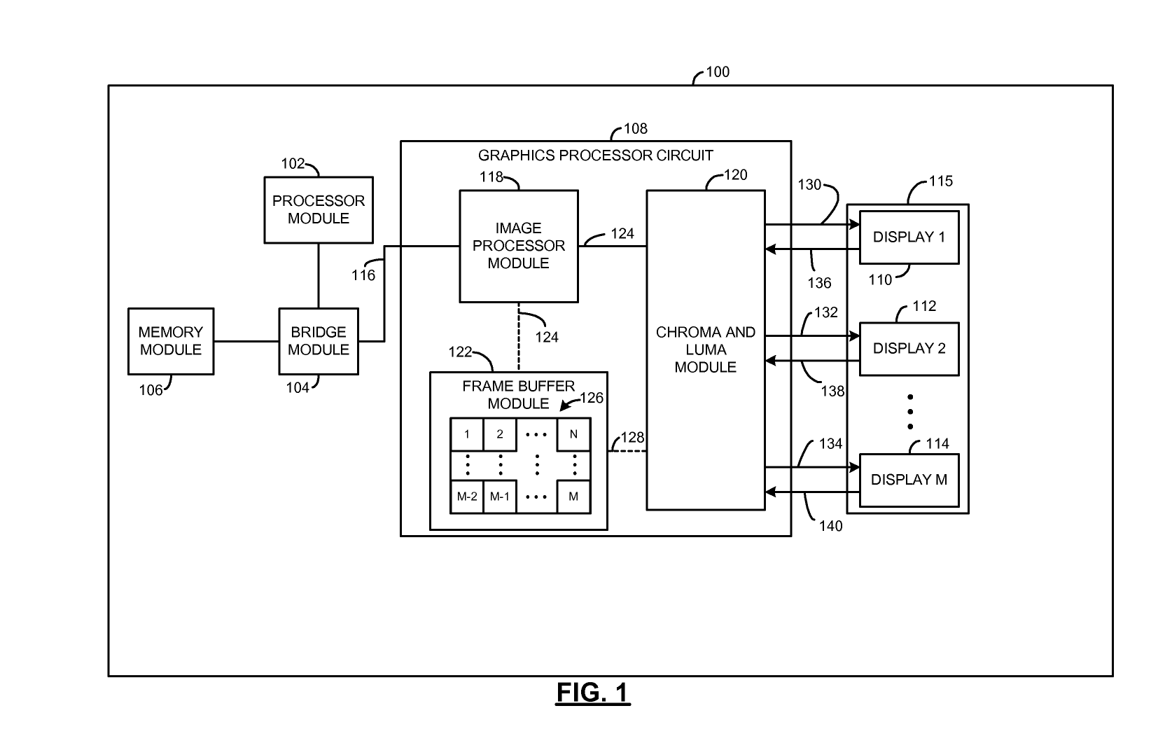

Referring now to FIG. 1, an exemplary functional block diagram of a device 100 such as a wireless phone, a mobile and/or stationary computer, a printer, a LAN interface (wireless and/or wired), a media player, a video decoder and/or encoder, and/or any other suitable device is depicted. The device 100 includes a processor module 102, a bridge module 104, a memory module 106, a graphics processor module 108, and a plurality of displays 110, 112, 114. Although referred to as a graphics processor module in this example, skilled artisans will appreciate that the graphics processor module 108 can process video information in addition to graphics information. In addition, in some embodiments, the displays 110, 112, 114 can be external to the device 100 if desired.

The displays 110, 112, 114 are configured to collectively present an entire frame as a single large surface 115. Although not depicted, in some embodiments, there may be six displays aligned in a rectangular arrangement having three columns and two rows. As such, in this example, each of the displays can present ⅙ of a frame so that the combination of all the displays 110, 112, 114 present the entire frame as the single large surface 115. Although six displays are discussed in this example, it is contemplated that any number of displays can be included and arranged as desired.

The processor module 102 is operatively coupled to the bridge module 104 and processes requests from the bridge module 104. The memory module 106 stores information communicated from the bridge module 104. The bridge module 104 communicates image information 116 (e.g., drawing commands, and/or other suitable unprocessed image information) to the graphics processor module 108, which processes the information for presentation on the displays 110, 112, 114.

The graphics processor module 108 can include an image processor module 118, a chrominance and luminance module 120, and a frame buffer module 122 configured substantially as shown. The image processor module 118 provides processed image information 124 to the chrominance and luminance module 120 in response to the image information 116. In some embodiments, the image processor module 118 can provide the processed image information 124 to the frame buffer module 122 if desired. As shown, in this example, the processed image information 124 is stored as an entire image frame 126 having image frame portions (e.g., 1, 2, N, M−2, M−1, . . . , M) corresponding to each of the displays 110, 112, 114. More specifically, in this example, image frame portion 1 corresponds to display 110, image frame portion 2 corresponds to display 112, and image frame portion M corresponds to display 114 although other configurations are contemplated. The displays 110, 112, 114 display respective image frame portions (e.g., 1, 2, N, M−2, M−1, . . . , M) of the entire frame 126 to collectively present the single large surface 115 across the displays 110, 112, 114.

In response to the processed image information 124 (or stored processed image information 128), the chrominance and luminance module 120 selectively adjusts, on a per display basis, chrominance and luminance of respective streams of image information provided for each of the displays 110, 112, 114. More specifically, the chrominance and luminance module 120 adjusts chrominance and luminance of the processed image information 124 (or stored processed image information 128) to provide adjusted chrominance and luminance image information 130, 132, 134 for each respective display 110, 112, 114. The chrominance and luminance of the respective streams of image information (e.g., adjusted chrominance and luminance image information 130, 132, 134) are adjusted so that each of the displays 110, 112, 114 provide a substantially equivalent chrominance and luminance across the displays when displaying the single large surface 115. As such, different makes and/or models of displays can be used in conjunction to display the single large surface 115 without having differing chrominance and luminance characteristic for the various displays.

The chrominance and luminance module 120 selectively adjusts the chrominance and luminance of the respective streams of image information for each of the displays 110, 112, 114 based on display characteristics of each of the displays 110, 112, 114. The display characteristics provide information regarding each displays display characteristic capabilities such as luminance information (e.g., gamma or intensity characteristics) and chrominance information (e.g., color gamut). For example, if display 110 has a color gamut space defined by coordinates x_red=0.64, y_red=0.33, x_green=0.3, y_green=0.6, x_blue=0.15, y_blue=0.06 and displays 112, 114 have a color gamut space defined by coordinates x_red=0.735, y_red=0.265, x_green=0.274, y_green=0.717, x_blue=0.167, y_blue=0.009, the chrominance and luminance module 120 would adjust the processed image information 124 (or stored processed image information 128) so that a color gamut of a particular image would fall within common range (e.g., the overlapping area or intersection) color gamuts for all displays 110, 112, 114. As such, in this example, the chrominance and luminance module 120 can adjust the processed image information 124 (or stored processed image information 128) to have a color gamut space for all displays 110, 112, 114 defined by coordinates x_red=0.64, y_red=0.33, x_green=0.3, y_green=0.6, x_blue=0.167, y_blue=0.06.

The chrominance and luminance module 120 obtains respective display characteristic information 136, 138, 140 for each of the displays 110, 112, 114. The display characteristic information 136, 138, 140 can be any suitable information describing the characteristics (or capabilities) of the displays 110, 112, 114 such a chrominance ranges (e.g., color gamut), luminance ranges (e.g., gamma or intensity information), and/or other suitable information. In one embodiment, the display characteristic information 136, 138, 140 can comprise information in accordance with extended display identification information (EDID), Display Identification data (DisplayID), and/or other suitable information. In another embodiment, a user can visually perceive the chrominance and luminance characteristics of the displays 110, 112, 114 and provide the display characteristic information 136, 138, 140 based thereon. In yet another embodiment, a user can visually perceive (or measure) the chrominance and luminance characteristics of the displays 110, 112, 114 using known color calibration equipment such as a Konica Minolta CA-100 Color Analyzer for example.

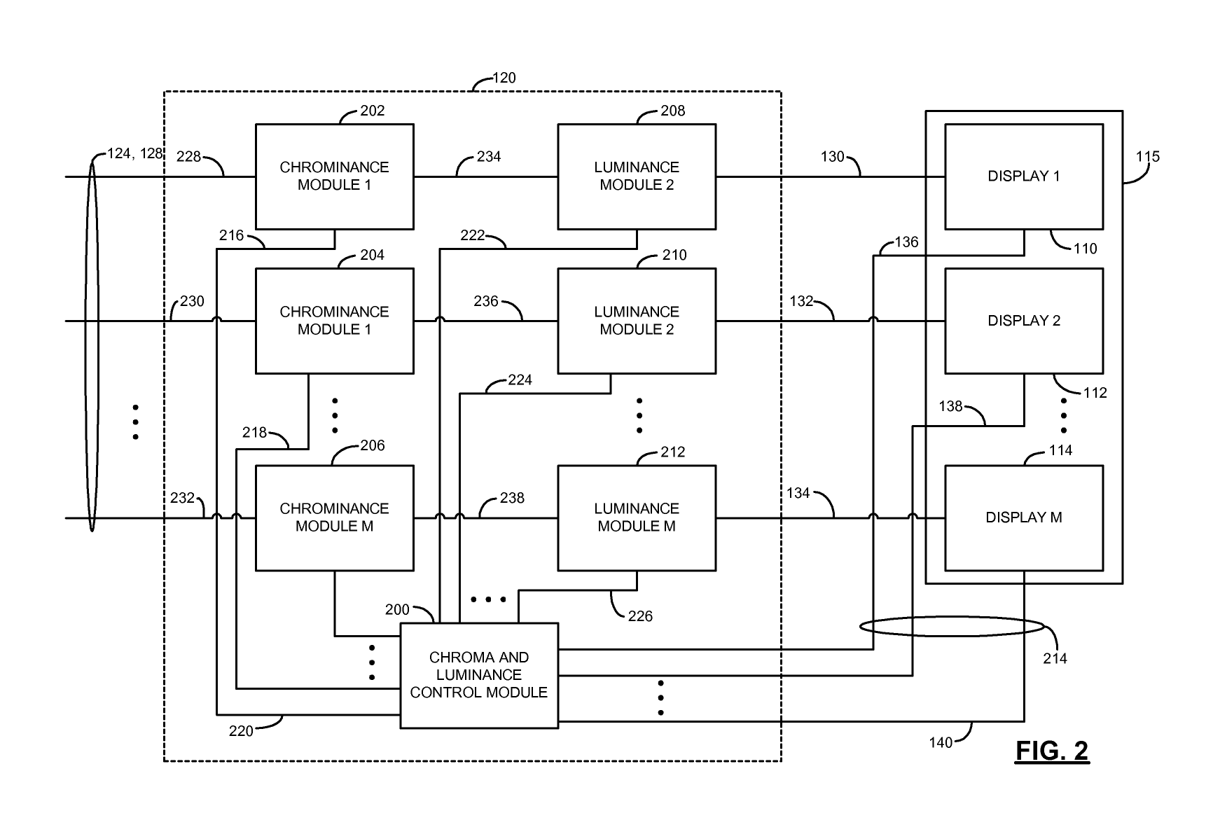

Referring now to FIG. 2, an exemplary functional block diagram of the chrominance and luminance module 120 is depicted. The chrominance and luminance module 120 includes a chrominance and luminance control module 200, multiple chrominance modules 202, 204, 206, and multiple luminance modules 208, 210, 212 substantially configured as shown. Although not depicted, the chrominance modules 202, 204, 206 and luminance modules 208, 210, 212 can be transposed so that a luminance operation is performed prior to a chrominance operation if desired. Each of the chrominance modules 202, 204, 206 are associated with a respective display 110, 112, 114. Likewise, each of the luminance modules 208, 210, 212 are associated with a respective display 110, 112, 114.

The chrominance and luminance control module 200 obtains display characteristic information 214 (e.g., 136, 138, 140) for each of the displays 110, 112, 114. The chrominance and luminance control module 200 determines common chrominance and luminance ranges that each of the displays 110, 112, 114 are capable of displaying. For example, in one embodiment, the chrominance and luminance control module 200 can determine common chrominance ranges based on an intersection of the gamut space for all the displays 110, 112, 114. Similarly, the chrominance and luminance control module 200 can determine common luminance ranges based on an intersection of the luminance information for all the displays 110, 112, 114.

The chrominance and luminance control module 200 provides chrominance range control information 216, 218, 220 based on a common chrominance range for each of the displays 110, 112, 114. Likewise, the chrominance and luminance control module 200 provides luminance range control information 222, 224, 226 based on a common luminance range for each of the displays 110, 112, 114. As such, the chrominance and luminance control module 200 essentially controls the chrominance modules 202, 204, 206 and luminance modules 208, 210, 212 to selectively adjust chrominance and luminance of the processed image information 124 (or stored processed image information 128) based on the chrominance range control information 216, 218, 220 and the luminance range control information 222, 224, 226, respectively. Although the chrominance range control information 216, 218, 220 is depicted as multiple information signals, the chrominance range control information 216, 218, 220 can be combined as a single chrominance range control information signal if desired. Likewise, the luminance range control information 222, 224, 226 can also be combined into a single luminance range control information signal if desired.

During operation, each of the chrominance modules 202, 204, 206 receive respective image information 228, 230, 232 corresponding with the processed image information 124 (or stored processed image information 128). In response thereto, each of the chrominance modules 202, 204, 206 selectively adjust the image information 228, 230, 232 based on the chrominance range control information 216, 218, 220 to provide respective adjusted chrominance image information 234, 236, 238. In response to the adjusted chrominance image information 234, 236, 238, each of the luminance modules 208, 210, 212 selectively adjust the adjusted chrominance image information 234, 236, 238 based on the luminance range control information 222, 224, 226 to provide the respective adjusted chrominance and luminance image information 130, 132, 134 for each respective display 110, 112, 114.

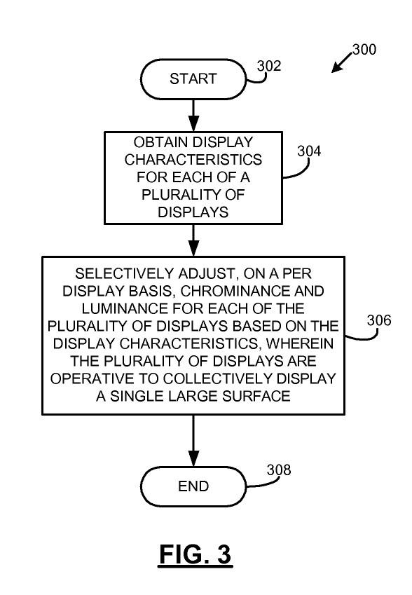

Referring now to FIG. 3, exemplary operations that can be performed by the chrominance and luminance module 120 are generally identified at 300. The process starts at 302. As 304, the chrominance and luminance module 120 obtains the respective display characteristics 136, 138, 140 for each of displays 110, 112, 114. At 306, the chrominance and luminance module 120 selectively adjusts, on a per display basis, chrominance and luminance of the respective streams of image information for the displays 110, 112, 114 so that the displays 110, 112, 114 can collectively display the single large surface 115 having substantially equivalent chrominance and luminance characteristics. More specifically, the chrominance and luminance module 120 selectively adjusts the image information 228, 230, 232 for each respective display 110, 112, 114 so that they collectively display the single large surface 115 having substantially equivalent chrominance and luminance characteristics. The process ends at 308.

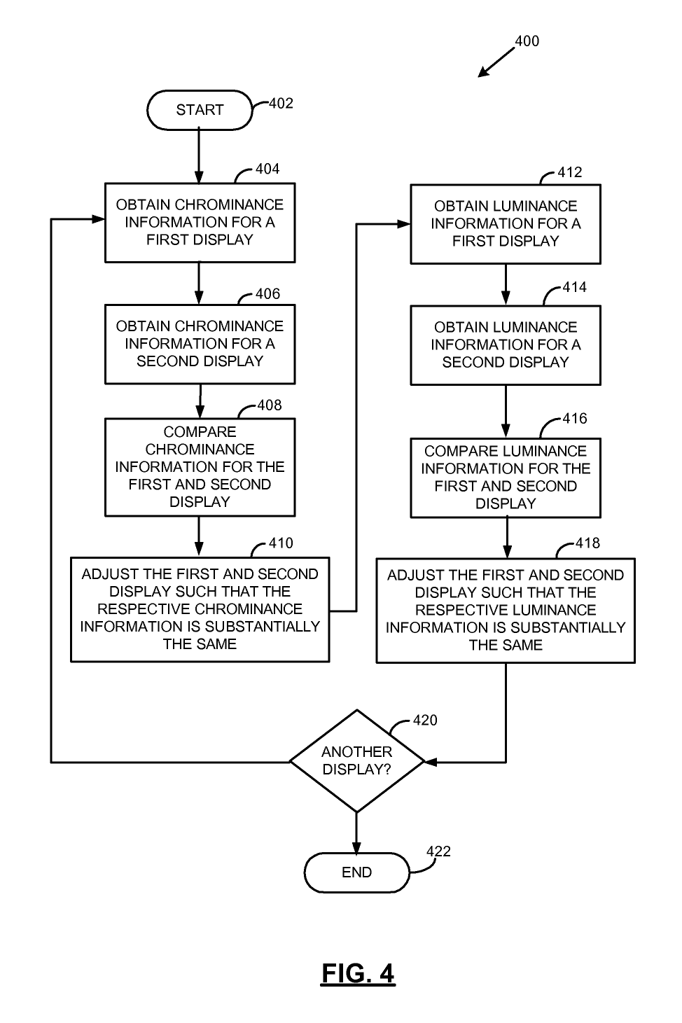

Referring now to FIG. 4, additional exemplary operations that can be performed by the chrominance and luminance module 120 are generally identified at 400. The process starts at 402. At 404, the chrominance and luminance control module 200 obtains chrominance information from the display characteristic information 136 associated with display 110. At 406, the chrominance and luminance control module 200 obtains chrominance information from the display characteristic information 138 associated with display 112. At 408, the chrominance and luminance control module 200 compares the chrominance information associated with display 110 and display 112 to determine a common chrominance range for each of the displays 110, 112. At 410, the chrominance and luminance control module 200 provides chrominance range control information 216, 218 to respective chrominance modules 202, 204, which selectively adjusts the image information 228, 230 so that the adjusted chrominance image information 234, 236 fall within a common chrominance range and the displays 110, 112 can display chrominance values that are substantially the same.

At 412, the chrominance and luminance control module 200 obtains luminance information from the display characteristic information 136 associated with display 110. At 414, the chrominance and luminance control module 200 obtains luminance information from the display characteristic information 138 associated with display 112. At 416, the chrominance and luminance control module 200 compares the luminance information associated with display 110 and display 112 to determine a common luminance range for each of the displays 110, 112. At 418, the chrominance and luminance control module 200 provides luminance range control information 222, 224 to respective luminance modules 208, 210, which selectively adjust the adjusted chrominance image information 234, 236 so that the adjusted chrominance and luminance image information 130, 132 fall within a common luminance range and the displays 110, 112 can display luminance values that are substantially the same.

At 420, the chrominance and luminance control module 200 determines whether the are other displays configured to display the single large surface 115. If there are additional displays (such as display 114 for example), the process returns to 404. However, if there are no more displays configured to display the single large surface 115, the process ends at 422.

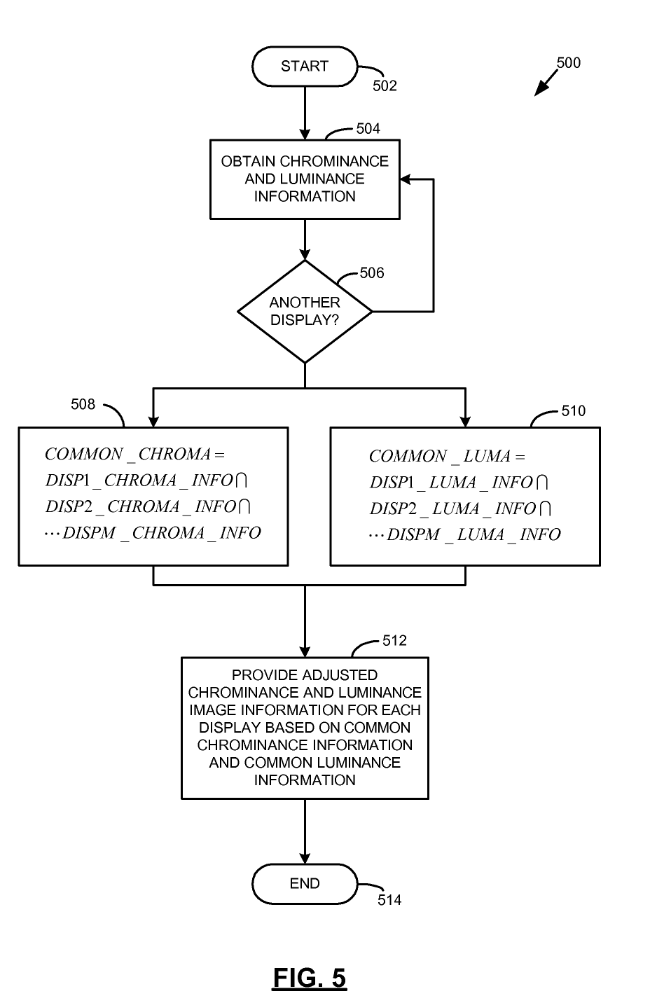

Referring now to FIG. 5, exemplary operations that can be performed by the chrominance and luminance module 120 are generally identified at 500. The process starts at 502. At 504, the chrominance and luminance module 120 obtains chrominance and luminance information from the display characteristic information for a respective display 110, 112, 114. At 506, the chrominance and luminance module 120 determines whether there is another display. If there is another display, the chrominance and luminance module 120 obtains chrominance and luminance information from the display characteristic associated with the display.

However, if there are no more displays associated with the graphics processor module 108, the process proceeds to 508 and 510. Although the process proceeds to 508 and 510 in parallel in this example, each process can be performed serially if desired. For example 508 can be performed and then 510 can be subsequently performed or vice versa.

At 508, the chrominance and luminance control module 200 determines a common chrominance range for the displays 110, 112, 114. As noted above, in one embodiment, the common chrominance range can be based on an intersection of the display chrominance information (e.g., gamut space) for each of the displays.

At 510, the chrominance and luminance control module 200 determines a common luminance range for the displays 110, 112, 114. As noted above, in one embodiment, the common luminance range can be based on an intersection of the display luminance information (e.g., gamma or intensity information) for each of the displays.

At 512, the chrominance and luminance module 120 provides the adjusted chrominance and luminance image information 130, 132, 134 for each respective display 110, 112, 114 so that the displays 110, 112, 114 can collectively present the single large surface 115 having substantially equivalent chrominance and luminance. The process ends at 514.

As noted above, among other advantages, the method and apparatus provide a substantially equivalent chrominance and luminance across the displays, for example, when displaying the single large surface. As such, different makes and/or models of displays can be used in conjunction to display the single large surface without having differing chrominance and luminance characteristic for the various displays. Other advantages will be recognized by those of ordinary skill in the art.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims. In addition, unless stated otherwise, terms such as “first” and “second” are used to arbitrarily distinguish between the elements such terms describe. Thus, these terms are not necessarily intended to indicate temporal or other prioritization of such elements. The term coupled, as used herein, is defined as connected, although not necessarily directly, and not necessarily mechanically. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms a or an, as used herein, are defined as one or more than one.

What is claimed is:

1. An apparatus comprising:
a chrominance and luminance module that is operative to:
obtain display characteristics of each of a plurality of displays; and
selectively adjust, on a per display basis, chrominance and luminance for each of the plurality of displays based on the display characteristics.

2. The apparatus of claim 1 wherein the chrominance and luminance module is operative to selectively adjust the chrominance based on a common chrominance range that each of the displays are capable of presenting, wherein the common chrominance range is based on the display characteristics of the plurality of displays.

3. The apparatus of claim 1 wherein the chrominance and luminance module is operative to selectively adjust the luminance based on a common luminance range that each of the displays are capable of presenting, wherein the common luminance range is based on the display characteristics of the plurality of displays.

4. The apparatus of claim 1 wherein the display characteristics comprise information in accordance with one of extended display identification data and display identification data.

5. The apparatus of claim 1 wherein the display characteristics are based on a visual perception of the plurality of displays collectively displaying the single large surface.

6. The apparatus of claim 1 wherein the chrominance and luminance of each of the plurality of displays are individually adjusted to provide a substantially equivalent chrominance and luminance across all of the plurality of displays when displaying the single large surface.

7. A method comprising:
obtaining display characteristics of each of a plurality of displays; and
selectively adjusting, on a per display basis, chrominance and luminance for each of the plurality of displays based on the display characteristics.

8. The method of claim 7 comprising selectively adjusting the chrominance based on a common chrominance range that each of the displays are capable of presenting, wherein the common chrominance range is based on the display characteristics of the plurality of displays.

9. The method of claim 7 comprising selectively adjusting the luminance based on a common luminance range that each of the displays are capable of presenting, wherein the common luminance range is based on the display characteristics of the plurality of displays.

10. The method of claim 7 wherein the display characteristics comprise information in accordance with one of extended display identification data and display identification data.

11. The method of claim 7 wherein the display characteristics are based on a visual perception of the plurality of displays collectively displaying the single large surface.

12. The method of claim 7 wherein the chrominance and luminance of each of the plurality of displays are individually adjusted to provide a substantially equivalent chrominance and luminance across all of the plurality of displays when displaying the single large surface.

13. A device comprising:
a chrominance and luminance module that is operative to:
obtain display characteristics of each of the plurality of displays; and
selectively adjust, on a per display basis, chrominance and luminance for each of the plurality of displays based on the display characteristics, wherein the plurality of displays are operative to collectively display a single large surface.

14. The device of claim 13 wherein the chrominance and luminance module is operative to selectively adjust the chrominance based on a common chrominance range that each of the displays are capable of presenting, wherein the common chrominance range is based on the display characteristics of the plurality of displays.

15. The device of claim 13 wherein the chrominance and luminance module is operative to selectively adjust the luminance based on a common luminance range that each of the displays are capable of presenting, wherein the common luminance range is based on the display characteristics of the plurality of displays.

16. The device of claim 13 comprising:
the plurality of displays; and
a graphics processing module, operatively coupled to the plurality of displays, that comprises the chrominance and luminance module.

17. An apparatus comprising:
a chrominance module that is operative to selectively provide, on a per display basis, adjusted chrominance display information for each of a plurality of displays in response to image information;
a luminance module that is operative to selectively provide, on a per display basis, adjusted luminance image information for each of the plurality of displays in response to the adjusted chrominance image information; and
a control module, operatively coupled to the chrominance module and the luminance module, that is operative to control the chrominance module to provide the provide the adjusted chrominance image information and the luminance module to provide the adjusted luminance information based on display characteristics of each of the plurality of displays.

18. The apparatus of claim 17 wherein the chrominance module is operative to provide the adjusted chrominance image information based on a common chrominance range that each of the displays are capable of presenting, wherein the common chrominance range is based on the display characteristics of the plurality of displays.

19. The apparatus of claim 17 wherein the luminance module is operative to provide the adjusted luminance image information based on a common luminance range that each of the displays are capable of presenting, wherein the common luminance range is based on the display characteristics of the plurality of displays.

20. The apparatus of claim 17 wherein the display characteristics comprise information in accordance with one of extended display identification data and display identification data.

21. The apparatus of claim 17 wherein the chrominance and luminance of each of the plurality of displays are individually adjusted to provide a substantially equivalent chrominance and luminance across all of the plurality of displays when displaying the single large surface.
